(19) United States
(12) Patent Application Publication
(10) Pub. No.: US 2006/0081011 A1
(43) Pub. Date: Apr. 20, 2006

(54) Sol-Gel process and method for manufacturing optical crystal fiber using the same

(75) Inventors: Keun-Deok Park, Sasang-gu (KR); Soon-Jae Kim, Gumi-si (KR); Jin-Han Kim, Gumi-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/206,634

(22) Filed: Aug. 18, 2005

(30) Foreign Application Priority Data
Oct. 18, 2004 (KR) 2004-83004

(51) Int. Cl. C03B 37/016

(52) U.S. Cl. 65/395; 65/440

(57) ABSTRACT

A sol-gel process is disclosed. The process includes forming a sol by dispersing an organic binder and at least two kinds of fumed silica having different particle sizes into de-ionized water and forming a gel by injecting the dispersed sol into a mold.

### CLAIM OF PRIORITY

This application claims priority to an application entitled “Sol-Gel Process and Method for Manufacturing Optical Crystal Fiber Using the Same,” filed with the Korean Intellectual Property Office on Oct. 18, 2004 and assigned Serial No. 2004-83004, the contents of which are hereby incorporated by reference.

### BACKGROUND OF THE INVENTION

1. Field of the Invention

The present invention relates to a method for manufacturing optical fiber preforms and optical crystal fibers, and more particularly to a method for manufacturing optical fiber preforms and optical crystal fibers using a sol-gel process.

2. Description of the Related Art

In general, silica glass is transparent and chemically inactive. It has excellent physical and chemical characteristics such as thermal stability and strength. In addition, silica glass has low thermal expansion coefficient and is widely used to manufacture optical devices such as optical fibers, optical crystal fibers, and lenses.

Methods for manufacturing optical fibers and optical crystal fibers include a vapor axial deposition method and a sol-gel process. The sol-gel process is conducted in a liquid state. Using the sol-gel process the product composition can be adjusted as desired. The sol-gel process is performed at a lower temperature than the vapor axial deposition method. The sol-gel process is more economical process than the vapor axial deposition process and can also create compositions of with complex components.

In a typical sol-gel process, alkoxysilane is added to a solution, such as alcohol or de-ionized water, to induce hydrolysis reaction. If the hydrolysis reaction is induced under an acid catalyst, a chemically cross-coupled integral gel is obtained, and under a basic catalyst, a colloidal silica sol is obtained.

After the hydrolysis reaction, the resulting substances are injected into a forming mold for a molding process to obtain a final gel. The gel may be varied by the solution (such as alcohol or de-ionized water), the ratio of included alkoxysilane, and the pH of hydrolysis compositions.

The created gel is dried for a period of time and is subjected to heat treatment at a temperature of 700° C. or more. According to the mold type, a tube-type secondary preform, which is used to manufacture an optical fiber preform, or an optical crystal fiber is formed. The tube-type secondary preform has a hollow extending through the center thereof. A rod for forming a core portion is inserted into the hollow of the secondary preform and seals it to complete an optical fiber preform.

However, silica glass manufactured through the sol-gel process is subjected to a very large stress during drying due to small pores. The stress during drying of gel substantially changes the contraction of completed silica glass. As a result, the gel cracks and is vulnerable to stress during drying.

### SUMMARY OF THE INVENTION

One aspect of the present invention is to provide a sol-gel process capable of suppressing decrease in coupling force among particles.

One embodiment of the present invention is directed to a sol-gel process including a dispersion step for forming a sol by dispersing an organic binder and at least two kinds of fumed silica having different particle sizes into de-ionized water and a forming step for forming a gel by injecting the dispersed sol into a mold.

### BRIEF DESCRIPTION OF THE DRAWINGS

The above and other aspects, features and embodiments of the present invention will be more apparent from the following detailed description taken in conjunction with the accompanying drawings, in which:

FIG. 1 is a flowchart showing steps of a sol-gel process according to an embodiment of the present invention;

FIG. 2 is a flowchart showing sub-steps of the dispersion step shown in FIG. 1; and

FIG. 3 shows fumed silica added to de-ionized water during the sol formation step shown in FIG. 2.

### DETAILED DESCRIPTION

Hereinafter, embodiments of the present invention will be described with reference to the accompanying drawings. For the purposes of clarity and simplicity, a detailed description of known functions and configurations incorporated herein will be omitted as it may obscure the subject matter of the present invention.

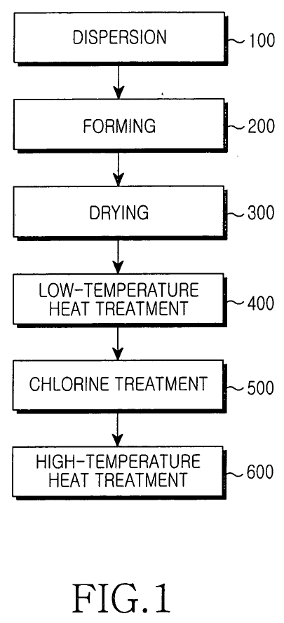

FIG. 1 is a flowchart showing steps of a sol-gel process according to an embodiment of the present invention. The method includes a dispersion step 100 of creating a sol, a forming step 200 of injecting the dispersed sol into a mold to form a gel, a drying step 300, a low-temperature heat treatment step 400, a chlorine treatment step 400, and a high-temperature heat treatment step 600.

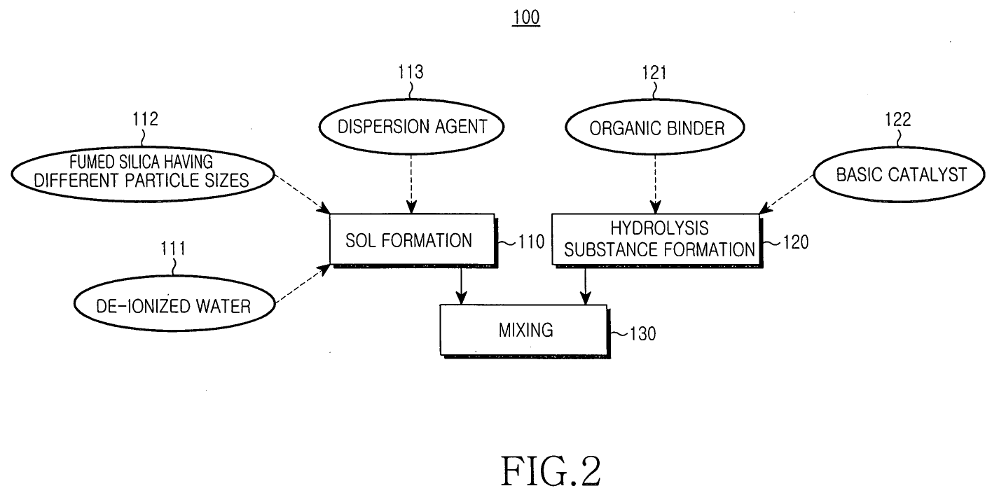

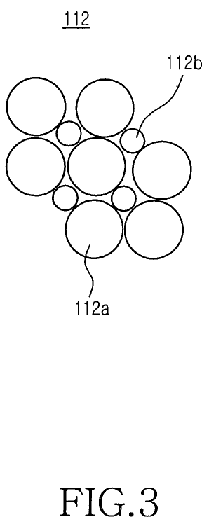

FIG. 2 is a flowchart showing sub-steps of the dispersion step 100 shown in FIG. 1. FIG. 3 shows fumed silica 112 added to de-ionized water during the sol formation step 110 shown in FIG. 2. Referring to FIGS. 2 and 3, the dispersion step 100 includes a sol formation step 110 of fabricating a dispersed sol by adding fumed silica 112 (112a and 112b) into a solution such as de-ionized water 111, a hydrolysis substance formation step 120 of forming a hydrolysis substance including an organic binder 121 and a basic catalyst 122, and a mixing step 130.

In the sol formation step 110, first fumed silica 112a and second fumed silica 112b having a particle size corresponding to 15-30% of that of the first fumed silica 112a are dispersed into the de-ionized water 111 together with a dispersion agent 113 and a plasticizer. In addition to the de-ionized water 111, alcohol may also be used as the solution.

As the first fumed silica 112a, OX-50 (Degussa) powder having larger particles may be used and, as the second fumed silica 112b, Aerosil 200 having smaller particles than the first fumed 112a silica may be used. The OX-50 used as the first fumed silica 112a has larger particles than the second fumed silica 112b and can be easily dispersed. It can also be easily dried when the solution is removed for drying, due to large pores, but it does not have enough strength after gelling.

Therefore, use of a material (such as Aerosil 200) having smaller particles than the first fumed silica 112a, as the second fumed silica 112b, increases the coupling force among particles added to the de-ionized water 111 and maintains high strength after gelling. The first and second fumed silica 112a and 112b may be added to the de-ionized water at the ratio of 7:3. If the ratio is not met, pores of the sol may become excessively small and cause dry cracking.

In the hydrolysis substance formation step 120, a hydrolysis substance having an organic binder 121 and a basic catalyst 122 added thereto is formed. In the mixing step 130, the sol and the hydrolysis substance are mixed to create a final sol.

In the forming step 200, the mixed sol is injected into a mold having a predetermined shape to form a gel. According to the mold type, a secondary preform, which is used to manufacture an optical fiber preform, or an optical crystal fiber is formed. The forming step 200 includes a molding step for injecting the mixed sol into the mold for gelling and a de-molding step for separating the gel created in the molding step from the mold.

In the drying step 200, the gel separated from the mold is dried in a chamber having constant temperature and humidity.

In the low-temperature heat treatment step 400, the dried gel is subjected to heat treatment while supplying chlorine, hydrogen, oxygen, and the like to remove organic substances remaining in the gel. In the chlorine treatment step 500, impurities remaining in the gel and OH radicals are removed.

In the low-temperature heat treatment step 400 and the chlorine treatment step 500, which are also referred to as a purification step, impurities within the dried gel are removed.

In the high-temperature heat treatment step 600, the gel which has undergone the low-temperature heat treatment step 400 and the chlorine treatment step 500 are sintered and consolidated at a high temperature of 1200-1600° C. to vitrify it. As a result, a secondary preform to manufacture an optical fiber preform, an optical crystal fiber, or normal silica glass is obtained. The high-temperature heat treatment step 600 is performed with a furnace which vertically moves the gel, which has been subjected to organic substance treatment, in a high-temperature sintering furnace under a helium (He) gas atmosphere.

When an optical crystal fiber is to be manufactured, the sol-gel process according to aspects of the present invention further includes a drawing step of drawing an optical crystal fiber from the gel, which has been consolidated and vitrified in the high-temperature heat treatment step 500.

One advantage of the above described sol-gel processes in that the strength of an optical fiber preform or optical crystal fiber by forming a sol from different kinds of fumed silica having different particle sizes can be improved as compared to the conventional methods.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A sol-gel process comprising:
forming a sol having at least two kinds of fumed silica having different particle sizes dispersed into de-ionized water; and
forming a gel by injecting the dispersed sol into a mold.

2. A sol-gel process as claimed in claim 1, further comprising:
drying the gel which has been formed;
removing organic substances remaining in the gel by a heat treatment;
removing OH radicals remaining in the gel by a chlorine treatment; and
heating the consolidation of the gel.

3. A sol-gel process as claimed in claim 1, wherein the gel is consolidated at a temperature of at least 1200-1600° C.

4. A sol-gel process as claimed in claim 1, wherein the step of forming the sol comprises:
dispersing first fumed silica and second fumed silica having a particle size corresponding to 15-30% of that of the first fumed silica into the de-ionized water;
forming a hydrolysis substance having an organic binder and a basic catalyst added thereto; and
adding the hydrolysis substance into the sol.

5. A sol-gel process as claimed in claim 4, wherein the first and second fumed silica are added to the de-ionized water at a ratio of 7:3.

6. A sol-gel process as claimed in claim 4, wherein a dispersion agent and a plasticizer are added to the de-ionized water.

7. A method for manufacturing an optical crystal fiber using a sol-gel process comprising:
creating a sol by dispersing an organic binder, first fumed silica, and second fumed silica having a particle size corresponding to 20-30% of that of the first fumed silica into de-ionized water;
injecting the dispersed sol into a mold to form a gel;
drying the gel;
removing organic substances remaining in the gel by a heat treatment;
removing impurities remaining in the gel and OH radicals by a chlorine treatment;
heating the gel to improve its consolidation; and
drawing an optical crystal fiber from the consolidated gel.

8. The method as claimed in claim 7, wherein the gel is consolidated at a temperature of at least 1200-1600° C.
